(19) United States
(12) Patent Application Publication
(10) Pub. No.: US 2026/0004165 A1
(43) Pub. Date: Jan. 1, 2026

(54) INFORMATION PROCESSING

(71) Applicant: Beijing Zitiao Network Technology Co., Ltd., Beijing (CN)

(72) Inventor: Haoming ZHENG, Beijing (CN)

(21) Appl. No.: 18/984,625

(22) Filed: Dec. 17, 2024

(30) Foreign Application Priority Data
Jun. 30, 2024 (CN) 202410870520.1

(51) Int. Cl. G06N 5/04

(52) U.S. Cl. CPC G06N 5/04

(57) ABSTRACT

Embodiments of the disclosure provide a solution for information processing. The method includes: in response to detecting a predetermined mentioning symbol input by a user in an interactive interface, providing a presentation of a digital assistant list in the interactive interface based on at least one of: interaction context information in the interactive interface or at least one historical interaction operation of the user for a digital assistant, the digital assistant list comprising at least one candidate digital assistant; in response to detecting a determination of a target digital assistant, receiving a request for the target digital assistant; and in response to receiving the request, providing, in the interactive interface, a response to the request via the target digital assistant.

### CROSS-REFERENCE

This application claims priority to Chinese patent application No. 202410870520.1, filed on Jun. 30, 2024 and entitled “METHOD, APPARATUS, DEVICE, STORAGE MEDIUM AND PROGRAM PRODUCT FOR INFORMATION PROCESSING”, which is incorporated herein by reference in its entirety.

### TECHNICAL FIELD

Example embodiments of the present disclosure generally relate to the field of computers, and more particularly, to information processing.

### BACKGROUND

With the development of information technologies, various terminal devices can provide various services for people in aspects of work, life, and the like. For example, an application providing a service may be deployed in a terminal device, and the terminal device or the application may provide a digital assistant type function for a user, so as to assist the user in using the terminal device or the application. The user may complete diversified operations through various interactions with the digital assistant.

### SUMMARY

In a first aspect of the present disclosure, a method of information processing is provided. The method includes: in response to detecting a predetermined mentioning symbol input by a user in an interactive interface, providing a presentation of a digital assistant list in the interactive interface based on at least one of: interaction context information in the interactive interface or at least one historical interaction operation of the user for a digital assistant, the digital assistant list comprising at least one candidate digital assistant; in response to detecting a determination of a target digital assistant, receiving a request for the target digital assistant; and in response to receiving the request, providing, in the interactive interface, a response to the request using the target digital assistant.

In a second aspect of the present disclosure, an apparatus for information processing is provided. The apparatus includes: a list presenting module configured to, in response to detecting a predetermined mentioning symbol input by a user in an interactive interface, provide a presentation of a digital assistant list in the interactive interface based on at least one of: interaction context information in the interactive interface or at least one historical interaction operation of the user for a digital assistant, the digital assistant list comprising at least one candidate digital assistant; a request receiving module configured to, in response to detecting a determination of a target digital assistant, receive a request for the target digital assistant; and a response providing module configured to, in response to receiving the request, provide, in the interactive interface, a response to the request using the target digital assistant.

In a third aspect of the present disclosure, an electronic device is provided. The device includes: at least one processing unit; and at least one memory coupled to the at least one processing unit and storing instructions for execution by the at least one processing unit, the instructions, when executed by the at least one processing unit, causing the electronic device to perform the method of the first aspect.

In a fourth aspect of the disclosure, a computer readable storage medium having a computer program stored thereon is provided. The computer program is executable by a processor to perform operations that implement the method of the first aspect.

In a fifth aspect of the disclosure, a computer program product including a computer program is provided, wherein the computer program, when executed by a processor, performs operations that implement the method of the first aspect of the present disclosure.

It should be appreciated that the content described in this section is not intended to limit critical features or essential features of the embodiments of the present disclosure, nor is it intended to limit the scope of the present disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment.

FIG. 2 illustrates a flowchart of an example method of information processing.

FIGS. 3A-3I illustrate example interfaces.

FIG. 4 illustrates an example of a signaling flow for information processing.

FIG. 5 illustrates an example of a signaling flow for information processing.

FIG. 6 illustrates an example structural block diagram of an apparatus for information processing.

FIG. 7 illustrates a block diagram of an example electronic device.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are provided for illustrative purposes only and are not intended to limit the scope of protection of the present disclosure.

In the description of the embodiments of the present disclosure, the term “including” and the like should be understood as non-exclusive inclusion, that is, “including but not limited to”. The term “based on” should be understood as “based at least in part on.” The term “one embodiment” or “the embodiment” should be understood as “at least one embodiment”. The term “some embodiments” should be understood as “at least some embodiments”. Other explicit and implicit definitions may also be included below.

In this specification, unless explicitly stated otherwise, performing a step “in response to A” does not mean that the step is performed immediately after “A”, but may include one or more intermediate steps.

It will be appreciated that the data involved in the technical solution (including but not limited to the data itself, the obtaining or use of the data) should comply with the requirements of the corresponding legal regulations and related provisions.

It will be appreciated that, before using the technical solutions disclosed in the various embodiments of the present disclosure, the user shall be informed of the type, application scope, and application scenario of the personal information involved in this disclosure in an appropriate manner and the user's authorization shall be obtained, in accordance with relevant laws and regulations. The related users may include any type of right holder, such as individuals, enterprises, and groups.

For example, in response to receiving an active request from a user, prompt information is sent to the relevant user to explicitly prompt the relevant user. An operation requested to be executed by the user needs to obtain and use information of a related user, so that the related user may autonomously select, according to prompt information, whether to provide information for software or hardware such as an electronic device, an application, a server, or a storage medium that executes the operations of the technical solutions of the present disclosure.

As an optional but non-limiting implementation, in response to receiving an active request from the user, prompt information is sent to the user, for example, in the form of a pop-up window, and the pop-up window may present the prompt information in the form of text. In addition, the pop-up window may also carry a selection control for the user to select whether he/she “agrees” or “disagrees” to provide personal information to the electronic device.

It should be understood that the above notification and user authorization process are only illustrative which do not limit the implementation of this disclosure. Other methods that meet relevant laws and regulations can also be applied to the implementation of this disclosure.

As used in this specification, the term “model” may refer to a structure that learns associations between corresponding inputs and outputs from training data, so that after the training is complete, a corresponding output may be generated for a given input. The generation of the model may be based on a machine learning technology. Deep learning is a machine learning algorithm that processes inputs and provides corresponding outputs by using a multi-tiered processing unit. A neural network model is one example of a model based on deep learning. Herein, “model” may also be referred to as “machine learning model”, “learning model”, “machine learning network”, or “learning network”, which may be used interchangeably herein.

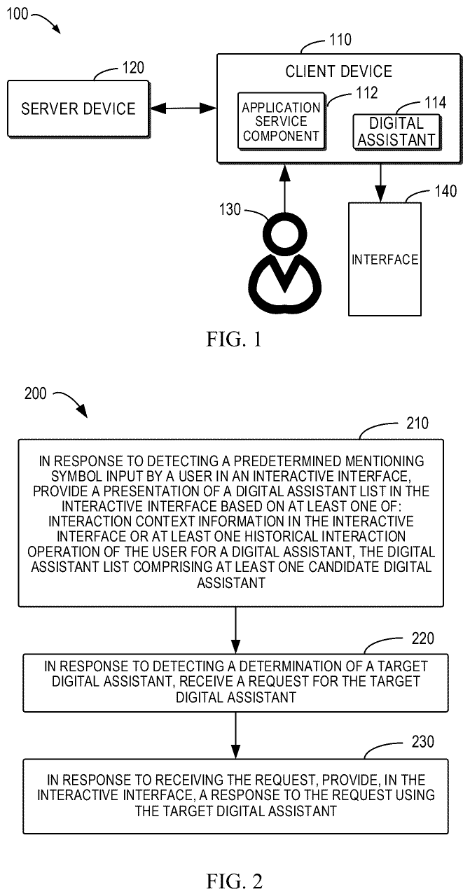

FIG. 1 shows a schematic diagram of an example environment 100 in which embodiments of the present disclosure can be implemented. In this example environment 100, an application service component 112 and a digital assistant 114 are installed in a client device 110. A user 130 may interact with the application service component 112 and the digital assistant 114 via the client device 110 and/or an attached device of the client device 110.

In some embodiments, the application service component 112 and the digital assistant 114 may be downloaded and installed at client device 110. In some embodiments, the application service component 112 and the digital assistant 114 may also be accessed in other ways, such as through a web page, etc. In some embodiments, in environment 100 of FIG. 1, in response to the application service component 112 being started, the client device 110 can present an interface 140 of the digital assistant 114 and the application service component 112. The interface 140 may be, for example, an interactive interface of the application service component 112 with the digital assistant 114.

The application service component 112 includes, but is not limited to, one or more of the following: a chat application component (also referred to as an instant messaging application component), a document application component, an audio-video conference application component, a mail application component, a task application component, a calendar application component, an objective and key result (OKR) application component, and the like. It shall be appreciated that although a single application service component is shown in FIG. 1, a plurality of application service components may be installed on the client device 110. In some embodiments, the application service component 112 may include a multifunctional collaborative platform. For example, an office collaborative platform (also referred to as an office suite) can provide integration of multiple types of service components, so as to facilitate people's activities such as office work and communication. In a multifunctional cooperative platform, people can start different service components as needed to complete corresponding information processing, sharing, communication, etc.

In some embodiments, the digital assistant 114 may be provided by a separate application service component, or may be integrated within some application service component 112 that is capable of providing a content entity. An application service component for providing a client interface for a digital assistant may correspond to a single-function application service component or a multi-function collaborative platform, such as an office suite or other collaborative platform capable of integrating a plurality of components. It can be understood that although a single digital assistant is shown in FIG. 1, in practice, a plurality of digital assistants may exist, which is similar to the application service components.

In some embodiments, the digital assistant 114 supports usage of plug-ins. Each plug-in can provide one or more functions of an application. Such plug-ins include, but are not limited to, one or more of search plug-ins, contact plug-ins, message plug-ins, document plug-ins, table plug-ins, mail plug-ins, calendar plug-ins, schedule plug-ins, task plug-ins, and the like.

The digital assistant 114 is an intelligent assistant of the user and has an intelligent dialog and information processing capability. In the embodiments of the present disclosure, the digital assistant 114 is configured to interact with a user 130, so as to assist the user 130 in using a terminal device or an application. In some embodiments, an interaction window with the digital assistant 114 may be presented in the interface 140. In the interaction window, the user 130 can have a dialog with the digital assistant 114 by inputting natural language text, a picture, an audio file, a video file, a webpage file, and the like, so as to instruct the digital assistant to assist in completing various tasks, including operations on the content entity 126.

In some embodiments, a plurality of interaction modes may be provided between the user 130 and the digital assistant 114, and switching may be performed flexibly between the plurality of interaction modes. In the event that a certain interaction mode is triggered, a corresponding interaction area is presented to facilitate interaction of the user 130 with the digital assistant 114. In different interaction modes, interaction manners of the users 130 with the digital assistant 114 are different, so that an interaction requirement in different application scenarios can be flexibly adapted.

In some embodiments, an information processing service specific to the user 130 can be provided based on historical interaction information of the user 130 with the digital assistant 114 and/or data range specific to the user 130. In some embodiments, historical interaction information about interaction of the user 130 with the digital assistant 114 in a plurality of interaction modes, respectively, may all be stored in association with the user 130. As such, in one of the plurality of interaction modes (anyone or a specified one of the interaction modes), the digital assistant 114 may provide services to the user 130 based on historical interaction information stored in association with the user 130.

The digital assistant 114 may be invoked or awakened in an appropriate manner (e.g., shortcut, button, or voice) to present an interaction window with the user 130. The interaction window with the digital assistant 114 may be opened by selecting the digital assistant 114. The interaction window may include interface elements for information interaction, such as input boxes, message lists, message bubbles, and so on. In some other embodiments, the digital assistant 114 may be awakened through an entry control or a menu provided in the interface 140, or may be awakened by entering a preset instruction.

The interaction window for the digital assistant 114 with the user 130 may include a conversation window, such as a conversation window in an instant messaging module of a specific application or an instant messaging application. In a conversation window, the interaction between the digital assistant 114 and the user 130 may be presented in the form of a conversation message. Alternatively or additionally, the interaction window of the digital assistant 114 with the user 130 may also include other types of windows, such as a floating window mode window, wherein the user 130 may trigger the digital assistant 114 to perform a corresponding operation by inputting an instruction, selecting a shortcut instruction, or the like.

In some embodiments, the digital assistant 114 may support an interaction mode of a conversation window, also referred to as a conversation mode. In the interaction mode, a conversation window between the user 130 and the digital assistant 114 is presented, through which, the user 130 interacts with the digital assistant 114 through a conversation message. In the conversation mode, the digital assistant 114 may perform a task according to the conversation messages in the conversation window. In the interaction window, the user 130 inputs an interaction message, and the digital assistant 114 provides a reply message in response to the user input. By selecting the digital assistant 114, a conversation window with the digital assistant 114 may be opened. The conversation window may include interface elements for information interaction, such as input boxes, message lists, message bubbles, and so on.

In some embodiments, the client device 110 communicates with a server device 120 to enable provision of the services to the digital assistant 114 and the service component 125. The client device 110 may be any suitable type of mobile terminal, fixed terminal, or portable terminal including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a game device, or any combination of the foregoing, including accessories and peripherals for these devices, or any combination thereof. In some embodiments, the client device 110 can also support any type of interface for the user (such as “wearable” circuitry, etc.). The server device 120 may be various types of computing systems/servers capable of providing computing capabilities, including, but not limited to, mainframe computers, edge computing nodes, computing devices in a cloud environment, etc.

It should be understood that the structure and function of the various elements in environment 100 are described for example purposes only and are not intended to imply any limitation on the scope of the disclosure.

As mentioned previously, users may complete diversified operations through a variety of interactions with digital assistants. Different digital assistants may have different capabilities, and a user may complete different operations by interacting with different digital assistants. For example, a user may obtain food recommended by the digital assistant by interacting with the digital assistant having a food recommendation function, the user may obtain an analysis result sent by the digital assistant for a movie by interacting with the digital assistant having a movie resolution function, and the like. Conventionally, if a user desires to interact with a digital assistant having a particular function, the user is generally required to manually select a target digital assistant having the function from a plurality of digital assistants. This may affect the efficiency of a user in selecting a target digital assistant. It is expected to be able to easily and quickly recommend a suitable digital assistant for the user.

In view of this, according to an embodiment of the present disclosure, an improved solution for information processing is provided. According to the solution of the embodiments of the present disclosure, in response to detecting a predetermined mentioning symbol input by a user in an interactive interface, a presentation of a digital assistant list is provided in the interactive interface based on at least one of interaction context information in the interactive interface and at least one historical interaction operation of the user for a digital assistant, the digital assistant list comprising at least one candidate digital assistant. In response to detecting a determination of a target digital assistant, a request for the target digital assistant is received. In response to receiving the request, a response to the request is provided in the interactive interface via the target digital assistant.

In this way, the candidate digital assistant may be quickly presented for user selection based on the user's interaction context information in the interactive interface and/or at least one historical interaction operation of the user with respect to the digital assistant. This can conveniently and quickly recommend a digital assistant to a user, thereby improving the convenience for the user to select the digital assistant, providing an efficiency of information processing, and improving user experience of the user interacting with the digital assistant.

Some example embodiments of the present disclosure will be described below with continued reference to the accompanying drawings.

FIG. 2 illustrates a flowchart of an example process 200 for information processing according to some embodiments of the present disclosure. For ease of discussion, the process 200 will be described with reference to the environment 100 of FIG. 1. The process 200 can be implemented at the client device 110 and/or the server device 120. For ease of description, the process 200 is illustrated as being implemented at the server device 120.

It should be noted that, if the description is provided by taking the process 200 implemented at the client device 110 as an example, some operations described with reference to the client device 110 may be completed with the assistance of the server device 120. It should be noted that the operations executed by the client device 110 may specifically be executed by a related application and/or a digital assistant installed on the client device 110.

At block 210, the server device 120, in response to detecting a predetermined mentioning symbol input by a user (e.g., user 130) in an interactive interface, provides, a presentation of a digital assistant list in the interactive interface based on at least one of interaction context information in the interactive interface and at least one historical interaction operation of the user for a digital assistant, the digital assistant list comprising at least one candidate digital assistant.

The interactive interface refers to an interface capable of receiving interaction information from a user and presenting response information to the user. In some examples, the interactive interface may include an interface associated with a post (e.g., an area corresponding to a body of the post, a comment area for the post, etc.) and a dialog window (e.g., a dialog window of the user with a further user, a dialog window of the user with a digital assistant, etc.). It should be noted that the interactive interface may further include any other suitable interface. It should be noted that if the interactive interface is a dialog window between the user and the digital assistant, the digital assistant corresponding to the dialog window and the candidate digital assistant in the digital assistant list may be different or may be the same.

The predetermined mentioning symbol may be any suitable mentioning symbol for mentioning a particular object. In some embodiments, the mentioning symbol may be, for example, a symbol “@”, a symbol “/”, and the like. An interactive interface (e.g., interface 140) provided by the client device 110 may include, for example, an input box. In response to receiving via the input box a predetermined mentioning symbol input by the user, the client device 110 may transmit an indication to server device 120 indicating that the predetermined mentioning symbol was detected in the interactive interface. The server device 120 may, in response to receiving the indication, determine that the predetermined mentioning symbol input by the user is detected in the interactive interface. In some embodiments, a mentioning control corresponding to a predetermined mentioning symbol may further be presented in the interactive interface. The client device 110 may, in response to receiving triggering for the mentioning control, transmit an indication to the server-end device 120 indicating that the predetermined mentioning symbol is detected in the interactive interface.

If the interactive interface is an interface associated with a post, the interaction context information in the interactive interface may include, for example, a post published by a user and a post that the user has interacted with (for example, a post collected by the user, a post liked by the user, a post commented on by the user, etc.), comments published by the user for the post, comments published by a further user/digital assistant for the post published by the user/for the post that the user has interacted with, replies by the user to comments of a further user/digital assistant, replies by a further user/digital assistant to comments of the user, etc.

If the interactive interface is a dialog window, the interaction context information in the interactive interface may include, for example, multiple rounds of dialogue the user has had with a further user/digital assistant over a history. Note that in some embodiments, the interaction context information may also include user input currently entered by the user. For example, the interaction context information may also include user inputs received by the client device 110 via an input box. The at least one historical interaction operation of the user with respect to the digital assistant may include a collection behavior on the user for the digital assistant, or an interaction operation of the user with the digital assistant, etc. The interaction operation with a digital assistant may indicate that the user has historically interacted with the digital assistant. The collection behavior or operation refers to associating a digital assistant or application with a particular collection list, which is associated with a user. For example, the collection list is created, favored, or saved by the user. The collection behavior may also be referred to as a favorite behavior or operation, a save behavior or operation, etc.

In some embodiments, the server device 120 may select one or more candidate digital assistants from a plurality of candidate digital assistants based on a match between description information of the plurality of candidate digital assistants and the interaction context information. For example, the server device 120 may determine, based on the interaction context information, a target function and/or target name that the digital assistant to be selected should have. The server device 120 may select one or more candidate digital assistants having a target function and/or a target name from the description information of the plurality of candidate digital assistants.

Alternatively or additionally, in some embodiments, the server device 120 may also select one or more digital assistants involved in the at least one historical interaction operation as one or more candidate digital assistants. For example, a digital assistant collected by the user, a digital assistant that has been historically interacted with the user, etc. may be determined to be one or more candidate digital assistants.

If the one or more candidate digital assistants determined based on the interaction context information and/or the at least one historical interaction operation only include one candidate digital assistant, the server device 120 may directly provide the candidate digital assistant to the user. If the determined one or more candidate digital assistants include a plurality of candidate digital assistants, in order to facilitate a user in selecting a desired digital assistant from the plurality of candidate digital assistants, the server device 120 may sort the plurality of candidate digital assistants, and determine the digital assistant list for presentation based on a result of the sorting.

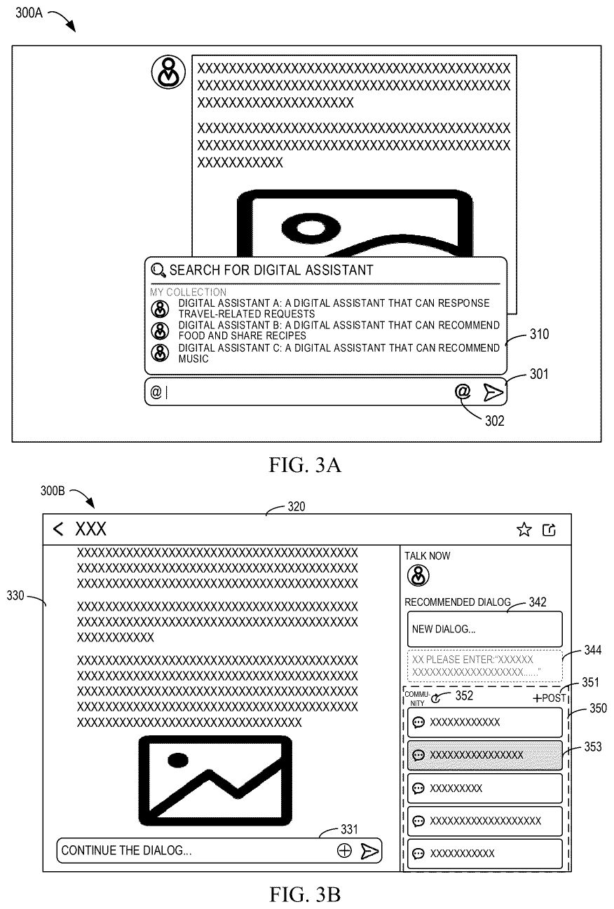

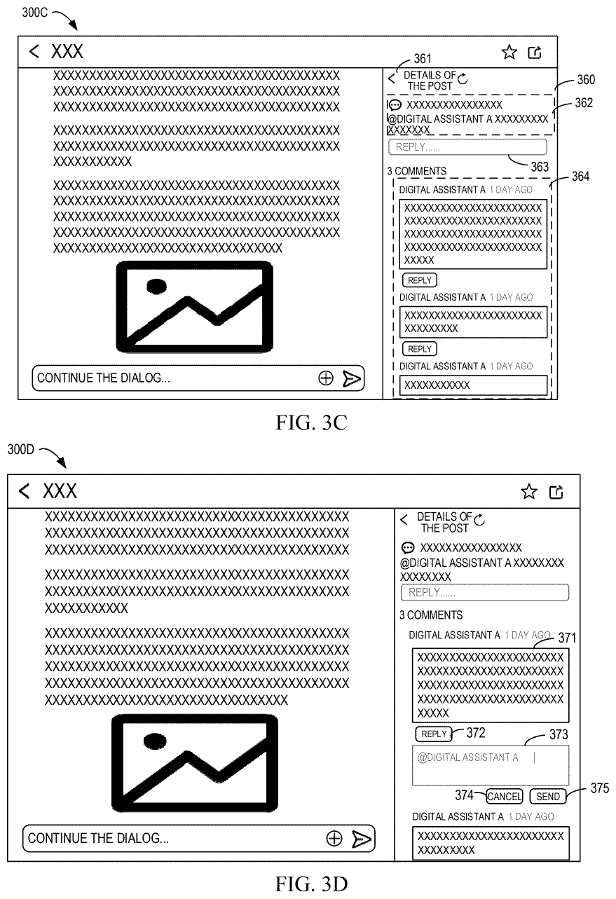

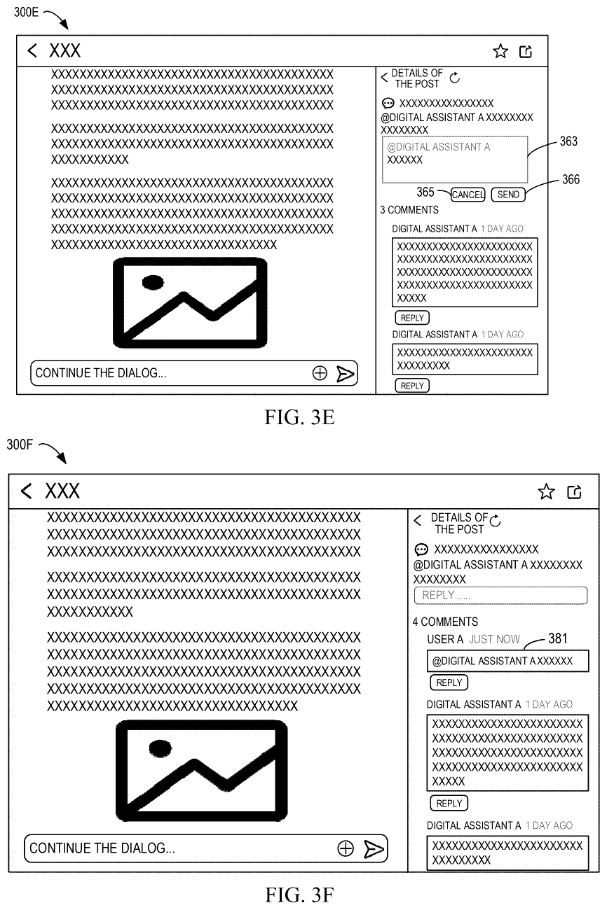

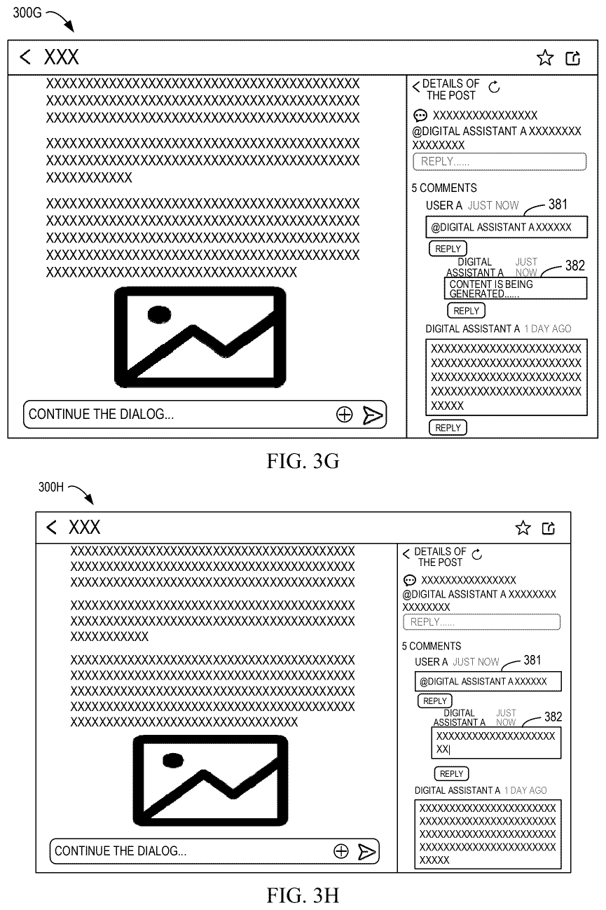

Referring to FIG. 3A, an example 300A illustrates an example of an interactive interface. The example 300A includes an input box 301 and a mentioning control 302. A digital assistant list 310 may be presented in response to receiving a symbol “@” via input box 301 or in response to receiving a trigger operation on a mentioning control 302. One or more candidate digital assistants determined by the service-side device 120 based on the interaction context information and/or at least one historical interaction operation may be presented in the digital assistant list 310.

With regard to a specific method for sorting a plurality of candidate digital assistants, in some embodiments, a server device 120 may sort a plurality of candidate digital assistants based on priority, and the respective priorities of the one or more candidate digital assistants can determined based on at least one historical interaction operation may be higher than priorities of one or more candidate digital assistants determined based on interaction context information. That is, the one or more candidate digital assistants determined based on the at least one historical interaction operation may be sorted ahead of the one or more candidate digital assistants determined based on the interaction context information.

Alternatively or additionally, in some embodiments, the server device 120 may also refer to one or more candidate digital assistants determined based on the interaction context information and one or more candidate digital assistants determined based on the at least one historical interaction operation as different types of candidate digital assistants. The server device 120 may also sort one or more candidate digital assistants of each type separately.

With regard to a specific method for selecting a digital assistant for each type, the server device 120 may, for example, sort a plurality of candidate digital assistants of a type based on priorities of the plurality of candidate digital assistants corresponding to the type. For example, for one or more candidate digital assistants determined based on the interaction context information, the server device 120 may determine that a priority of a candidate digital assistant determined based on the interaction context information with a corresponding point in time nearer to the current point in time is higher than a priority of a candidate digital assistant determined based on the interaction context information with a corresponding point in time farther from the current point in time. The server device 120 may sort, e.g., in descending order, one or more candidate digital assistants determined based on the interaction context information according to corresponding priorities, and a corresponding point in time of the interaction context information of a candidate digital assistant that is sorted higher in the sorting result is closer to the current time.

For example, for one or more candidate digital assistants determined based on at least one historical interaction operation, the server device 120 may determine a priority of the corresponding candidate digital assistant based on an operation type of the historical interaction operation. A priority of the candidate digital assistant determined based on a collection behavior may be higher than a priority of a candidate digital assistant determined based on the interaction operation. The server device 120 may sort, e.g., in descending order, one or more candidate digital assistants determined based on at least one historical interaction operation according to corresponding priorities, wherein a historical interaction operation corresponding to a candidate digital assistant sorted at the top in the sorting result may be, for example, a collection behavior, and a historical interaction behavior corresponding to a candidate digital assistant sorted at the bottom in the sorting result may be, for example, an interaction behavior.

In some embodiments, the server device 120 may also determine the digital assistant list based on a respective recommendation score of the at least one candidate digital assistant. The candidate digital assistant(s) herein may include the candidate digital assistants as determined above based on the interaction context information in the interactive interface and/or based on the at least one historical interaction operation by the user with respect to the digital assistant may include different digital assistants. The recommendation score of each digital assistant may be determined based on the number or frequencies of usages in a period of time (which may be the number or frequencies that a plurality of users use the digital assistant in a period of time), the number or frequencies of interactions with the users (which may be the number or frequencies of interactions with the plurality of users), the matching degree between the digital assistant and the popular topic, and the like. For example, a recommendation score corresponding to a digital assistant used by a large number of users within one month may be higher.

In this case, the server device 120 may determine a digital assistant list based on the interaction context information in the interactive interface, at least one historical interaction operation of the user with respect to the digital assistant, and respective recommendation scores of the candidate digital assistants. The digital assistant list determined in this way may include candidate digital assistants which are determined based on the interaction context information, candidate digital assistants which have been operated by the user in historical interaction, and candidate digital assistants with higher corresponding recommendation scores. A priority level of a candidate digital assistant operated by the user in a historical interaction may be higher than a priority level of a candidate digital assistant determined based on the interaction context information, and a priority level of a candidate digital assistant determined based on the interaction context information may be higher than a priority level of a candidate digital assistant with a higher corresponding recommendation score.

In some embodiments, the server device 120 may score each candidate digital assistant and the score may indicate a corresponding priority. It can be understood that the higher a priority corresponding to a candidate digital assistant is, the larger the value thereof is. The server device 120 may, for example, obtain a threshold score, and present only candidate digital assistants with corresponding scores higher than the threshold score in a digital assistant list.

At block 220, the server device 120, in response to detecting a determination of a target digital assistant, receives a request for the target digital assistant.

In some embodiments, the server device 120 may transmit the digital assistant list to the client device 110 for the client device 110 to present the digital assistant list to the user. In response to receiving a selection operation of a user for a certain candidate digital assistant in the digital assistant list, the client device 110 may determine the candidate digital assistant as a target digital assistant (namely, the client device 110 detects a determination for the target digital assistant). The client device 110, in turn, may transmit a corresponding indication to the server device 120 to inform the server device 120 that a determination of the target digital assistant has been detected.

In some embodiments, the server device 120 may also directly determine, in response to receiving a user input including specific name/specific description information about a digital assistant (namely, the user input may specify a certain digital assistant), a target digital assistant based on the user input. For example, if the text “@digital assistant A” is received via the input box, the server device 120 may determine the digital assistant A as the target digital assistant.

The received request for the target digital assistant may include content in any suitable format (e.g., picture, voice, text, video, audio, image set, file, etc.). The format may depend on the definition or data modality of the request in a specific application scenario.

At block 230, the server device 120, in response to receiving the request, provides, in the interactive interface, a response to the request via the target digital assistant.

In some embodiments, the client device 110 may trigger the server device 120 to determine a response to the request based on the configuration information of the target digital assistant and the interaction context information, and provide the response to the request in the interactive interface via the target digital assistant. The request may be considered as a question while the response may be considered as an answer to the question. For example, the configuration information may indicate a configuration, a rule, a version, etc. for the target digital assistant to generate the response. If the target digital assistant is configured to determine the response with the aid of a particular machine learning model, the target digital assistant may indicate the machine learning model and a prompt input for the machine learning model. This machine learning model may be based on any suitable model structure, including, but not limited to, a Transformer model, a convolutional neural network (CNN), a recurrent neural network (RNN), a deep neural network (DNN), etc. In some embodiments, the machine learning model may be based on a language model (LM). The language model can be provided with question-and-answer capabilities by learning from a lot of corpuses. The machine learning model may also be provided based on other suitable models.

The following description is provided by using an example in which a target digital assistant determines a response by means of a machine learning model, the server device 120 may determine, based on configuration information of the target digital assistant, a machine learning model for generating the response and a prompt template for generating a prompt input of the machine learning model. The server device 120 may generate the prompt input for the machine learning model, for example, by at least filling the request into a prompt template. In some embodiments, in order to improve the accuracy in generating a response, the server device 120 may also generate a prompt input for the machine learning model by filling the interaction context information and the request together into a prompt template.

The server device 120 may provide the prompt input to the machine learning model to obtain a response to the request from the machine learning model. The server device 120 may transmit the response to the client device 110. If the interactive interface is an interface associated with the post, the client device 110 may provide the response in the interactive interface in the form of a comment from the target digital assistant. If the interactive interface is a dialogue window, the client device 110 may provide a response in the form of a dialogue message from the target digital assistant.

With respect to a specific manner of providing the response, in some embodiments, the server device 120 may receive respective segments of the response from a machine learning model and cache one or more received segments of the response. For example, the response generated by the machine learning model may be a response in a text form, the machine learning model may generate the response word-by-word or phrase-by-phrase, and the server device 120 may also receive the response word-by-word or phrase-by-phrase from the machine learning model.

The server device 120 may, for example, in response to receiving a predetermined number of pieces of text, determine that a response to one segment is received. For example, the server device 120 may, in response to receiving 10 pieces of text, determine that a response to a segment is received. Alternatively or additionally, the server device 120 may also, in response to receiving a complete sentence or a complete paragraph, determine a response to the received segment.

The server device 120 may instantly cache a response to one segment in response to receiving the response to the segment. The server device 120 may also, in response to receiving the responses to the plurality of segments, cache responses to a predetermined number of segments. The server device 120 may, for example, cache responses to at least one segment to a database. The database may be a specific database used to cache the responses, and it may also be a universal database.

In response to detecting that a first client device is presenting the interactive interface, the server device 120 may, in turn, transmit the cached segments of the response to the first client device for presentation in the interactive interface. The server device 120 may, for example, sequentially transmit each cached segment to at least one client device by taking a segment as a unit. The at least one client device may present the responses in a streaming manner, in an order in which the segments were received.

It should be noted that the first client device may be a client device that receives the request. For example, if the interactive interface is a dialog window, the server device 120 may receive the request of the user from the client device 110, and transmit a response to the client device 110, so as to provide the user with a response to the request. In this case, the server device 120 may transmit only the cached segments to the client device 110.

The first client device 120 may also be a different client device than the one receiving the request. For example, if the interactive interface is an interface associated with the post, the server device 120 may receive a comment from the user for the post from the client device 110 and determine the comment as a request from the user. The response to the request provided by the server device 120 to the user may be, for example, a reply to the request. Since the post can be public and any user can view the interactive interface, comments to the post and replies to the comments can all be public. If there is further user viewing the interactive interface, the server device 120 may provide a response to a further client device corresponding to a further user. In this case, the server device 120 needs to transmit the cached segments to client devices corresponding to all users who are viewing the comment.

Thus, in the process of generating the response, the server device 120 does not need to wait for all responses being generated before providing the response to the user, and the server device 120 may cache the responses in segments and provide the responses to the user in a streaming manner, thereby improving the efficiency of obtaining the responses by the user.

In some embodiments, the server device 120 may also, in response to detecting a request from a second client device for presenting the interactive interface, determine that a generation of the response is not completed. It can be understood that, in a case that the generation of the response is not completed, since the server device 120 provides the responses in a streaming manner, the responses provided in the interactive interface are only a part of all the responses, and the client device presenting the interactive interface cannot provide a complete response for the user. The second client device may be a client device corresponding to a user that re-enters the interactive interface after exiting the interactive interface halfway, or the second client device may be a client device corresponding to a user that enters for the first time in the response generating process of the digital assistant.

The server device 120 may transmit the cached segments of the response to the second client device for presentation. For example, if three segments of responses have been cached, the server device 120 may provide the three segments of responses to the client device at a time. The client device may provide the three segments of responses together to the user. The server device 120 may further, in response to receiving a further segment of the response from the machine learning model, transmit the further segment to the second client device. That is, the server device 120 may further continue to receive a new segment and cache the new segment. The server device 120 may continue to sequentially provide new segments to the client device. In this case, the server device 120 may provide the cached segments at a time and provide new segments in a streaming manner.

Thus, in the process of generating a response, both the user who exits the interactive interface halfway and the user who accesses the interactive interface for the first time can directly view all the generated responses, and can continue to obtain the subsequent generated responses in a streaming manner.

Referring to FIGS. 3B-3I, examples 300B-300I illustrate various examples of an interactive interface. The example 300B includes an area 320 and an area 330. The area 330 can present content of a certain document, as an example, the area 320 may be configured to present a document name and at least one operation control (e.g., a like control, a collect control, a forward control, etc.) for the document. It can be understood that the content presented at the area 330 may also be any appropriate content such as content of a webpage and content of a body of a post, and the area 320 is configured to present a title, a name, etc. corresponding to the content at the area 330. The area 330 may include, for example, an input box 331. The user publishes comments for the content in the area 330, for example, through the input box 331. The example 300B can also include an input box 342, as well as an example 344. The user can also publish comments for the content in the area 330 via the input box 342, for example. The example 344 can be configured, for example, to illustrate an example of a user input that can notify the user how to input a comment.

The example 300B may further include an area 350. The area 350, for example, can be configured to present at least one post for content in the area 330. The area 350 includes a post control 351 and a refresh control 352. A user may publish a post by triggering the post control and may refresh at least one post presented in the area 350 by triggering the refresh control 352. The server device 120 may present the example 300C, e.g., in response to receiving a selection operation for the post 353 in the area 350. The example 300C includes an area 360, which can be, for example, an area corresponding to the body of the post, and an area 364, which can be, for example, a comment area for the post. The example 300C includes a return control 361, and the server device 120 may, in response to receiving a triggering for the return control 361, return to the interface providing Example 300B.

The area 360 may present a body 362 of a post and an input box 363 for the body 362. The server device 120 may receive comments for body 362, e.g., via input box 363. The area 360 may be presented with at least one comment for a post and a reply control for each comment. Referring to FIG. 3D, the server device 120 may, for example, determine to receive a comment for the comment 371 in response to receiving a triggering for the reply control 372 of the comment 371. The server device 120 may, for example, provide an input box 373 for the comment 371 and receive the comment for the comment 371 via the input box 373. The server device 120 may provide a cancel control 374 and a send control 375 in association with the input box 373. In response to receiving a selection operation for the cancel control 374, the server device 120 may not publish the comment received via the input box 373. The server device 120 may publish the comment received via the input box 373 in response to receiving the selection operation for the send control 375. This comment would be presented in association with comment 371.

In some embodiments, as illustrated in FIGS. 3C and 3E, the server device 120 may, in response to receiving a triggering on the input box 363 in the example 300C, present the example 300E. The size of the input box 363 may increase, for example, as the comment content input by the user increases until a predetermined size is reached. The server device 120 may provide a cancel control 365 and a send control 366 in association with the input box 363. The server device 120 may not publish the comment received via the input box 363 in response to receiving a selection operation for the cancel control 365. The server device 120 may publish the comment received via the input box 363 in response to receiving the selection operation for the send control 366. This comment may be presented, for example, in the area 364. As shown in FIG. 3F, the server device 120 may present a comment 381 from the user in the comment area.

Since the comment 381 mentions the digital assistant A, the server device 120 may determine the digital assistant A as the target digital assistant. The server device 120 may, for example, provide a response to the comment 381 (i.e., a reply to the comment 381) using the digital assistant A. In some embodiments, in a case where no segment of the response is obtained, the server device 120 may present a prompt message for prompting the user that the response is currently being obtained. The server device 120 provides a prompt message, for example, via the digital assistant A. The server device 120 may provide an interface shown in an example 300G. In an example 300G, the server device 120 may provide a prompt message (namely, a text “Content Generation in progress . . . ”) in a comment 382 from the digital assistant A for the comment 381.

Further, the server device 120 may, in response to obtaining one or more segments of the response, present the segments of the response in a streaming manner. As shown in FIG. 3H, in an example 300H, the server device 120 may provide segments of the response in the comment 382 from digital assistant A in a streaming manner. The server device 120 may present the interface shown in an example 300I in response to having obtained and cached all segments of the response. In the example 300I, the server device 120 may present a complete response in the comment 382.

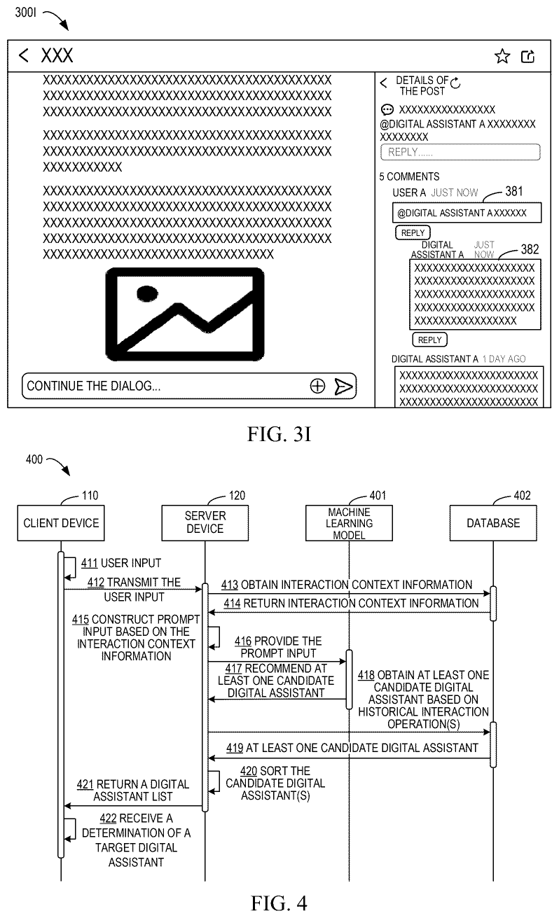

FIG. 4 illustrates an example of a signaling flow 400 for information processing, in accordance with some embodiments of the disclosure. The signaling flow 400 involves the client device 110, a server device 120, a machine learning model 401, and a database 402.

The client device 110 may (411) receive the user input in the interactive interface and transmit (412) the user input to the server device 120. The server device 120 may transmit (413) a request to the database 402 instructing to obtain the interaction context information of the user in the interactive interface. The database 413 may return (414) the interaction context information of the user in the interactive interface to the server device 120 upon request.

The server device 120 may, for example, determine at least one candidate digital assistant for the user based on the interaction context information. The server device 120 may determine at least one candidate digital assistant in any suitable manner. In some embodiments, the server device 120 may construct (415) a prompt input for the machine learning model 401 based on the interaction context information. The server device 120 may provide (416) the prompt input to a machine learning model 401. The machine learning model 401 may, for example, determine at least one candidate digital assistant based on the prompt input. The server device 120 may obtain (417) a model output from the machine learning model 401, which may indicate a recommendation to at least one candidate digital assistant. The model output may include, for example, a name, description information, identification, number, etc. of the at least one candidate digital assistant.

The server device 120 may also transmit, to the database 402, a request for instructing to obtain (418) at least one candidate digital assistant based on at least one historical interaction operation by the user with respect to the digital assistant, to obtain (419) the at least one candidate digital assistant from the database 402. It should be noted that the server device 120 may both execute obtaining of at least one candidate digital assistant from the machine learning model 401 and execute obtaining of at least one candidate digital assistant from the database 402, and may also only obtain at least one candidate digital assistant from the machine learning model 401 or only obtain at least one candidate digital assistant from the database 402.

The server device 120 may sort the at least one candidate digital assistant based on a priority of each candidate digital assistant (420). The server device 120 may determine a digital assistant list based on the sorting result, and return (421) the digital assistant list to the client device 110. In turn, the client device 110 may present the digital assistant list to the user, and receive 422 a determination by the user for a target digital assistant.

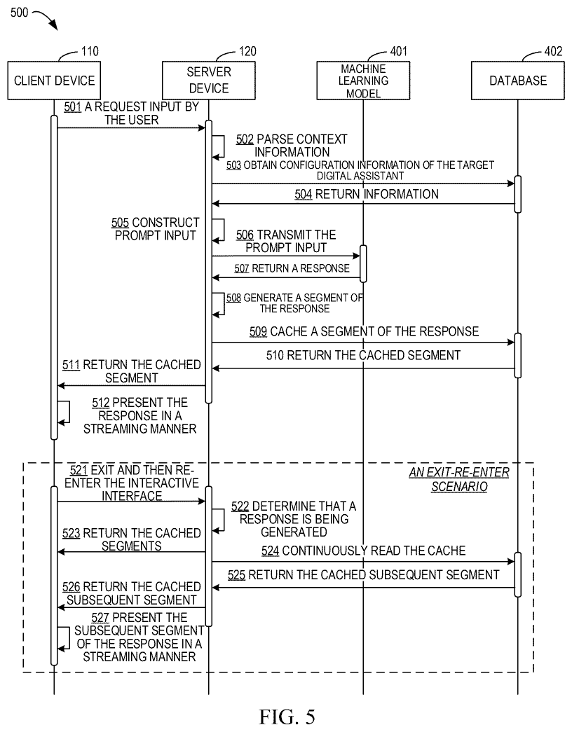

FIG. 5 shows an example of a signaling flow 500 for information processing according to some other embodiments of the present disclosure. The signaling flow 500 may also involve the client device 110, the server device 120, the machine learning model 401, and the database 402.

The client device 110, for example, may transmit (501) the request input by the user and received in the interactive interface to the server device 120. The server device 120 may obtain and parse (502) the context information (e.g., historical dialog information) of the user's request. The server device 120 may transmit (503) to the database 402 a request for instructions to obtain the configuration information for the target digital assistant. The database 402 may return (504) configuration information for the target digital assistant to the server device 120 based on the request.

If the configuration information instructs the target digital assistant to generate a response by means of a machine learning model (e.g., a machine learning model 401), the server device 120 may construct (505) a prompt input for the machine learning model 401 based on the request and the context information. The server device 120 may transmit (506) a prompt input to the machine learning model 401 and obtain (507) a response generated by the machine learning model 401 from the machine learning model 401. The machine learning model 401, for example, may generate the response word-by-word or phrase-by-phrase, and correspondingly, the server device 120 may obtain the response word-by-word or phrase-by-phrase from the machine learning model 401.

The server device 120 may generate (508) segments of the response based on the received content. The server device 120 may, for example, transmit the segments of the response to the database 402 to cache (509) the segments of the response. The server device 120 may also obtain (510) the cached segments from the database 402 and transmit (511) the cached segments to the client device 110. The client device 110 may provide the received segments to the client device 110 to present the response to the user in the interactive interface by the client device 110 (512) in a streaming manner. That is, by the caching mechanism, the effect of the streaming presentation may be achieved from the perspective of the client device.

Although FIG. 5 illustrates providing a response to a client device that put forward a request, in some embodiments, an interactive interface receiving a request for the target digital interface and a response may also be accessible by other client devices. For example, if the interactive interface is a public post page, when a first user puts forward a request via an associated first client device, the server device 120 may also return content of a response to further client device segment by segment in a similar process as described above, if the further client devices is generating the response to the request when accessing the current interactive interface. In this way, the streaming presentation of the response can also be achieved on the further client device.

In some embodiments, in an exit-re-enter scenario, after exiting the interactive interface, the client device 110 re-enters the interactive interface, and the client device 110 may transmit (521) a request to the server device 120 for instructing itself to exit and then re-enter the interactive interface. The server device 120 may, in response to the request, determine 522 that there is a response being generated (i.e., that generation of the response has not been completed). The server device 120 may transmit 523 the cached segment in the response to the client device 110, so that the client device 110 presents the cached segment to the user. The server device 120 may continuously transmit 524 to the database 402 a request for instructing to obtain the latest cached segments (i.e., may continuously read the cache). The database 402 may transmit 525 to the server device 120 the newly cached segment (i.e., return the cached subsequent segment to the server device 120) based on the request. The server device 120 may return (526) the cached subsequent segments to the client device 110. The client device 110 may present (527) to the user the subsequent segments of the response in a streaming manner after the previously presented cached segment.

That is to say, in the existing and reconnecting scenario, when accessing the interactive interface, the client device 110 may first view part of the content of the response which has been uploaded currently, and the subsequent content may still be presented on the interactive interface in a streaming manner. Similarly, the exiting and reconnecting scenario described above is also applicable to other client devices corresponding to non-problem initiators.

In conclusion, according to the embodiments of the present disclosure, at least one candidate digital assistant for a user can be determined based on interaction context information by the user in an interactive interface and/or at least one historical interactive operation of the user with respect to the digital assistant, and a response can be provided to the user via the target digital assistant based on the selection of the target digital assistant by the user. The digital assistant can be recommended to a user conveniently and quickly, thereby improving the convenience for the user to select the digital assistant, providing the efficiency of information processing, and improving the user experience of the user interacting with the digital assistant.

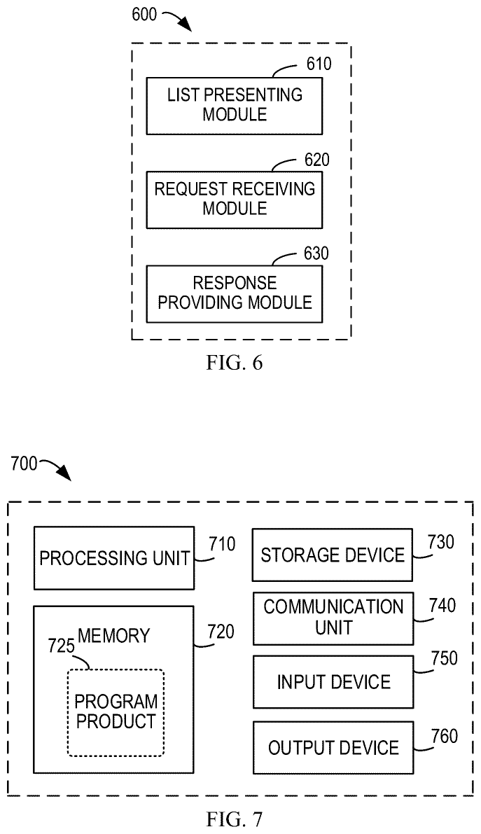

Embodiments of the present disclosure also provide corresponding apparatus for implementing the methods or processes described above. FIG. 6 illustrates an example structural block diagram of an apparatus 600 for information processing according to some embodiments of the present disclosure. The apparatus 600 may be implemented as or included in the client device 110 and/or a server device 120. The various modules/components in apparatus 600 may be implemented by hardware, software, firmware, or any combination thereof.

As shown in FIG. 6, the apparatus 600 includes a list presenting module 610 configured to, in response to detecting a predetermined mentioning symbol input by a user in an interactive interface, provide a presentation of a digital assistant list in the interactive interface based on at least one of interaction context information in the interactive interface or at least one historical interaction operation of the user for a digital assistant, the digital assistant list comprising at least one candidate digital assistant. The apparatus 600 also includes a request receiving module 620 configured to, in response to detecting a determination of a target digital assistant, receive a request for the target digital assistant. The apparatus 600 also includes a response providing module 630 configured to, in response to receiving the request, provide, in the interactive interface, a response to the request using the target digital assistant.

In some embodiments, the list presenting module 610 includes an executing module configured to perform at least one of the following: selecting one or more candidate digital assistants from a plurality of candidate digital assistants based on a match between description information of the plurality of candidate digital assistants and the interaction context information, or selecting one or more digital assistants involved in the at least one historical interaction operation as one or more candidate digital assistants; a sorting module configured to sort the selected candidate digital assistants; and a presenting module configured to determine the digital assistant list for presentation based on a result of the sorting.

In some embodiments, the sorting module is further configured to sort the selected candidate digital assistants based on a priority corresponding to the interaction context information and at least one corresponding priority of the at least one historical interaction operation.

In some embodiments, the list presenting module 610 is further configured to: determine the digital assistant list further based on a respective recommendation score of the at least one candidate digital assistant.

In some embodiments, the at least one historical interaction operation comprises at least one of: a collection behavior on a digital assistant, or an interaction operation with a digital assistant.

In some embodiments, the interactive interface comprises at least one of: an area corresponding to a body of a post, a comment area for a post, a dialog window of the user and a further user, or a dialog window of the user and a digital assistant.

In some embodiments, the response providing module 630 includes: a response determining module configured to determine a response to the request based on configuration information of the target digital assistant and the interaction context information; and a first response providing module configured to provide, in the interactive interface, the response to the request using the target digital assistant.

In some embodiments, the response providing module 630 includes: a response generating module configured to receive respective segments of the response from a machine learning model, the machine learning model being configured to generate the response based at least on the request; a response caching module configured to cache one or more received segments of the response; and a response transmitting module configured to, in response to detecting that a first client device is presenting the interactive interface, transmit the cached segments of the response to the first client device for presentation in the interactive interface.

In some embodiments, the response providing module 630 further includes: a determining module configured to, in response to detecting a request from a second client device for presenting the interactive interface, determine that a generation of the response is not completed; a cache transmitting module configured to transmit the cached segments of the response to the second client device for presentation; and a segment transmitting module configured to, in response to receiving a further segment of the response from the machine learning model, transmit the further segment to the second client device.

The units and/or modules included in the apparatus 600 may be implemented in a variety of ways, including software, hardware, firmware, or any combination thereof. In some embodiments, one or more units and/or modules may be implemented using software and/or firmware, such as machine-executable instructions stored on a storage medium. In addition to or as an alternative to machine executable instructions, some or all of the units and/or modules in apparatus 600 may be implemented, at least in part, by one or more hardware logic components. For example but not limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

It should be understood that one or more steps of the above methods may be performed by a suitable electronic device or a combination of electronic devices. Such electronic devices or combinations of electronic devices may include, for example, the client device 110 and/or the server device 120 in FIG. 1.

FIG. 7 illustrates a block diagram of an electronic device 700 in which one or more embodiments of the present disclosure may be implemented. It should be understood that the electronic device 700 shown in FIG. 7 is merely an example and should not constitute any limitation on the functionality and scope of the embodiments described herein. The electronic device 700 shown in FIG. 7 may be used to implement the client device 110 and/or the server device 120 of FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communications units 740, one or more input devices 750, and one or more output devices 760. The processing unit 710 may be an actual or virtual processor and can perform various processes according to programs stored in the memory 720. In a multiprocessor system, a plurality of processing units execute computer executable instructions in parallel, so as to improve the parallel processing capability of the electronic device 700.

The electronic device 700 typically includes a number of computer storage media. Such media may be any available media that are accessible by electronic device 700, including, but not limited to, volatile and non-volatile media, removable and non-removable media. The memory 720 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium such as a flash drive, a magnetic disk, or any other medium that can be used to store information and/or data and that can be accessed within the electronic device 700.

The electronic device 700 may further include additional removable/non-removable, volatile/nonvolatile storage media. Although not shown in FIG. 7, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 implements communication with other electronic devices through a communication medium. In addition, functions of components of the electronic device 700 may be implemented by a single computing cluster or a plurality of computing machines, and these computing machines can communicate through a communication connection. Thus, the electronic device 700 may operate in a networked environment using logical connections to one or more other servers, network personal computers (PCs), or a further network node.

The input device 750 may be one or more input devices such as a mouse, keyboard, trackball, etc. The output device 760 may be one or more output devices such as a display, speaker, printer, etc. The electronic device 700 may also communicate with one or more external devices (not shown) such as a storage device, a display device, or the like through the communication unit 740 as required, and communicate with one or more devices that enable a user to interact with the electronic device 700, or communicate with any device (e.g., a network card, a modem, or the like) that enables the electronic device 700 to communicate with one or more other electronic devices. Such communication may be performed via an input/output (I/O) interface (not shown).

According to an example implementation of the present disclosure, a computer readable storage medium is provided, on which a computer-executable instruction is stored, wherein the computer executable instruction is executed by a processor to implement the above-described method. According to an example implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some updated implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description provides examples, not exhaustive, and the present application is not limited to the implementations as disclosed. Many modifications and variations will be apparent to one of ordinary skill in the art without departing from the scope and spirit of the implementations as described. The selection of terms used herein is intended to best explain the principles of the implementations, the practical application, or improvements to technologies in the marketplace, or to enable others of ordinary skill in the art to understand the implementations disclosed herein.

What is claimed is:

1. A method of information processing, comprising:
in response to detecting a predetermined mentioning symbol input by a user in an interactive interface, providing a presentation of a digital assistant list in the interactive interface based on at least one of: interaction context information in the interactive interface or at least one historical interaction operation of the user for a digital assistant, the digital assistant list comprising at least one candidate digital assistant;
in response to detecting a determination of a target digital assistant, receiving a request for the target digital assistant; and
in response to receiving the request, providing, in the interactive interface, a response to the request using the target digital assistant.

2. The method of claim 1, wherein providing a presentation of the digital assistant list in the interactive interface comprises:
performing at least one of:
selecting the at least one candidate digital assistant from a plurality of candidate digital assistants based on a match between description information of the plurality of candidate digital assistants and the interaction context information, or
selecting one or more digital assistants involved in the at least one historical interaction operation as the at least one candidate digital assistant;
sorting the selected at least one candidate digital assistant; and
determining the digital assistant list for presentation based on a result of the sorting.

3. The method of claim 2, wherein sorting the selected candidate digital assistants comprises:
sorting the selected at least one candidate digital assistant based on a priority corresponding to the interaction context information and at least one corresponding priority of the at least one historical interaction operation.

4. The method of claim 1, wherein providing a presentation of the digital assistant list in the interactive interface comprises:
determining the digital assistant list further based on a respective recommendation score of the at least one candidate digital assistant.

5. The method of claim 1, wherein the at least one historical interaction operation comprises at least one of: a collection behavior on a digital assistant, or an interaction operation with a digital assistant.

6. The method of claim 1, wherein the interactive interface comprises at least one of:
an area corresponding to a body of a post,
a comment area for a post,
a dialog window of the user and a further user, or
a dialog window of the user and a digital assistant.

7. The method of claim 1, wherein providing, in the interactive interface, the response to the request using the target digital assistant comprises:
determining a response to the request based on configuration information of the target digital assistant and the interaction context information; and
providing, in the interactive interface, the response to the request using the target digital assistant.

8. The method of claim 1, wherein providing, in the interactive interface, the response to the request using the target digital assistant comprises:
receiving respective segments of the response from a machine learning model, the machine learning model being configured to generate the response based at least on the request;
caching one or more received segments of the response; and
in response to detecting that a first client device is presenting the interactive interface, transmitting the cached segments of the response to the first client device for presentation in the interactive interface.

9. The method of claim 8, wherein providing, in the interactive interface, the response to the request via the target digital assistant further comprises:
in response to detecting a request from a second client device for presenting the interactive interface, determining that a generation of the response is not completed;
transmitting the cached segments of the response to the second client device for presentation; and
in response to receiving a further segment of the response from the machine learning model, transmitting the further segment to the second client device.

10. An electronic device, comprising:
at least one processing unit; and
at least one memory coupled to the at least one processing unit and storing instructions for execution by the at least one processing unit, the instructions, when executed by the at least one processing unit, causing the electronic device to perform the acts comprising:
in response to detecting a predetermined mentioning symbol input by a user in an interactive interface, providing a presentation of a digital assistant list in the interactive interface based on at least one of: interaction context information in the interactive interface or at least one historical interaction operation of the user for a digital assistant, the digital assistant list comprising at least one candidate digital assistant;
in response to detecting a determination of a target digital assistant, receiving a request for the target digital assistant; and
in response to receiving the request, providing, in the interactive interface, a response to the request using the target digital assistant.

11. The electronic device of claim 10, wherein providing a presentation of the digital assistant list in the interactive interface comprises:
performing at least one of:
selecting at least one candidate digital assistant from a plurality of candidate digital assistants based on a match between description information of the plurality of candidate digital assistants and the interaction context information, or
selecting one or more digital assistants involved in the at least one historical interaction operation as the at least one candidate digital assistant;
sorting the selected at least one candidate digital assistant; and
determining the digital assistant list for presentation based on a result of the sorting.

12. The electronic device of claim 11, wherein sorting the selected candidate digital assistants comprises:
sorting the selected at least one candidate digital assistant based on a priority corresponding to the interaction context information and at least one corresponding priority of the at least one historical interaction operation.

13. The electronic device of claim 11, wherein providing a presentation of the digital assistant list in the interactive interface comprises:
determining the digital assistant list further based on a respective recommendation score of the at least one candidate digital assistant.

14. The electronic device of claim 10, wherein the at least one historical interaction operation comprises at least one of: a collection behavior on a digital assistant, or an interaction operation with a digital assistant.

15. The electronic device of claim 10, wherein the interactive interface comprises at least one of:
an area corresponding to a body of a post,
a comment area for a post,
a dialog window of the user and a further user, or
a dialog window of the user and a digital assistant.

16. The electronic device of claim 10, wherein providing, in the interactive interface, the response to the request using the target digital assistant comprises:
determining a response to the request based on configuration information of the target digital assistant and the interaction context information; and
providing, in the interactive interface, the response to the request using the target digital assistant.

17. The electronic device of claim 10, wherein providing, in the interactive interface, the response to the request using the target digital assistant comprises:
receiving respective segments of the response from a machine learning model, the machine learning model being configured to generate the response based at least on the request;
caching one or more received segments of the response; and
in response to detecting that a first client device is presenting the interactive interface, transmitting the cached segments of the response to the first client device for presentation in the interactive interface.

18. The electronic device of claim 17, wherein providing, in the interactive interface, the response to the request via the target digital assistant further comprises:
in response to detecting a request from a second client device for presenting the interactive interface, determining that a generation of the response is not completed;
transmitting the cached segments of the response to the second client device for presentation; and
in response to receiving a further segment of the response from the machine learning model, transmitting the further segment to the second client device.

19. A non-transitory computer readable storage medium having a computer program stored thereon, the computer program being executable by a processor to implement the acts comprising:
in response to detecting a predetermined mentioning symbol input by a user in an interactive interface, providing a presentation of a digital assistant list in the interactive interface based on at least one of: interaction context information in the interactive interface or at least one historical interaction operation of the user for a digital assistant, the digital assistant list comprising at least one candidate digital assistant;
in response to detecting a determination of a target digital assistant, receiving a request for the target digital assistant; and
in response to receiving the request, providing, in the interactive interface, a response to the request using the target digital assistant.

20. The non-transitory computer readable storage medium of claim 19, wherein providing a presentation of the digital assistant list in the interactive interface comprises:
performing at least one of:
selecting the at least one candidate digital assistant from a plurality of candidate digital assistants based on a match between description information of the plurality of candidate digital assistants and the interaction context information, or
selecting one or more digital assistants involved in the at least one historical interaction operation as the at least one candidate digital assistant;
sorting the selected at least one candidate digital assistant; and
determining the digital assistant list for presentation based on a result of the sorting.
